(19) United States
(12) Patent Application Publication
(10) Pub. No.: US 2019/0026826 A1
(43) Pub. Date: Jan. 24, 2019

(54) ELECTRONIC SYSTEM AND METHOD FOR DETERMINING A CREDIT RISK SCORE FOR AN ONLINE MERCHANT

(71) Applicant: MASTERCARD INTERNATIONAL INCORPORATED, Purchase, NY (US)

(72) Inventors: Teja Chebrole, Gujarat (IN); Suneel Bhatt, Mayur Vihar (IN); Siddharth Rai, Varanasi (IN)

(21) Appl. No.: 16/043,967

(22) Filed: Jul. 24, 2018

(30) Foreign Application Priority Data
Jul. 24, 2017 (SG) 10201706018W

(51) Int. Cl. G06Q 40/02; G06Q 30/06

(52) U.S. Cl. CPC G06Q 40/025; G06Q 30/0607

(57) ABSTRACT

An electronic system and method is provided for determining a credit risk score for an online merchant. The system includes a transaction database including transaction data relating to payment card transactions performed by customers at multiple merchants, a financial performance database including financial data relating to multiple merchants selling merchandise through an e-commerce marketplace, and a risk assessment component. The risk assessment component is configured for: i) receiving, from a requester, an electronic request for a credit risk score for an online merchant, ii) extracting transaction data for the merchant and/or for similar merchants from the transaction database, iii) extracting financial data for the merchant and/or for similar merchants from the financial performance database, iv) combining the extracted transaction data and financial data in a statistical model to determine the credit risk score for the merchant, and v) transmitting the credit risk score to the requester.

### CROSS REFERENCE TO RELATED APPLICATIONS

This patent application claims priority to Singapore Patent Application No. 10201706018W filed on Jul. 24, 2017, the disclosure of which is incorporated by reference herein in its entirety as part of the present application.

### BACKGROUND

The present disclosure relates to an electronic system and method for determining a credit risk score for an online merchant.

Small and individual online enterprises are generally unable to obtain credit or loans from banks as they do not possess any credit history and are seen as presenting a high risk of failure by banks in view of stringent regulatory conditions. Consequently, there is a gap in the market for issuing credit to these suppliers, which is not adequately being fulfilled.

Recently, online marketplaces such as Amazon have taken steps to lend to their online merchants to facilitate such small online businesses. This creates a win-win situation for Amazon if the business of the merchant increases because Amazon benefits from the merchant selling more goods through its website as well as getting additional revenue in the form of interest on the credit provided. However, the risk of failure associated with the businesses of these merchants is not publicly available and Amazon (and others like them) need to estimate the risk accurately to remain profitable in this venture.

Consequently, there is a need for an electronic system and method for determining a credit risk score for an online merchant.

### BRIEF DESCRIPTION

A first aspect of the present disclosure provides an electronic system for determining a credit risk score for an online merchant including:
a) a transaction database including transaction data relating to payment card transactions performed by customers at multiple merchants;
b) a financial performance database including financial data relating to multiple merchants selling merchandise through an e-commerce marketplace; and
c) a risk assessment component configured for:
   i. receiving, from a requester, an electronic request for a credit risk score for an online merchant;
   ii. extracting transaction data for the merchant and/or for similar merchants from the transaction database;
   iii. extracting financial data for the merchant and/or for similar merchants from the financial performance database;
   iv. combining the extracted transaction data and financial data in a statistical model to determine the credit risk score for the merchant; and
   v. transmitting the credit risk score to the requester.

Embodiments of the disclosure therefore provide an electronic system that can estimate the credit risk of an online merchant using transaction data in combination with financial data from an ecommerce marketplace. Such credit risk scores can be used by banks and/or e-commerce marketplace providers (e.g., Amazon, ebay, or AliExpress) to better assess the risk of failure of the merchant and provide a clear quantitative basis for the issuance or refusal of a loan. Thus, embodiments of the disclosure will help to increase the issuance of loans to well-performing online merchants and reduce the risk of non-performing and bad loans. If a loan or credit facility is provided in light of a good credit risk score, the merchant may be able to use their additional funds to grow their business expeditiously.

Notably, the use of transaction data enables comparisons to be made with similar merchants to determine market factors and to assess how the merchant in question is performing with respect to its competitors, who may not operate through the same e-commerce marketplace. The credit risk scores may also be used to identify merchants with growing businesses, for example, by comparing scores from previous years.

The requester may, for example, be a bank, a loan provider, a potential investor, or an e-commerce marketplace provider. The system may be configured such that the requester may submit an individual enquiry for a credit risk score for a specified merchant. Alternatively, the system may be configured on a subscription-basis to provide, for example, monthly data for all or a selected group of merchants using an ecommerce marketplace.

The transaction data may include one or more of competitor spend data, industry spend data, and geography spend data.

The financial data may include stock keeping unit (SKU) data, income statements, balance sheets, cash flow, liquidity information, frequency of use, number of transactions per period, ticket size, daily/weekly/monthly/annual spend, etc.

The system may be configured in step (iv) to apply a weighting to the transaction data and/or financial data.

The system may further include a user interface through which a requester may submit the electronic request for a credit risk score. The user interface may be accessible via an internet-enabled device, for example via a website or user application.

The statistical model may determine the credit risk score for the merchant based on its relative position when compared with similar merchants. Consequently, the model may consider relative ratios of financial aspects in place of absolute numbers. The financial aspects may include a measure of financial stability, ability to meet short term and/or long term liquidity needs and/or an ability to meet other financial obligations. The following known financial ratios, amongst others, may be used by the model in calculating the credit risk score:
a. Current ratio
b. Quick ratio
c. Debt-to-Worth
d. Gross Margin Ratio
e. Net margin ratio
f. Sales to Assets
g. Return of Investment
h. Return on Assets
i. Inventory turnover
j. Inventory turnover days
k. Accounts receivable turnover
l. Average collection period
m. Accounts payable turnover
n. Accounts payment period

It is noted that the financial data is generally historical and may therefore contribute a lagging effect to the credit risk score of a merchant and hence it may have less predictive value compared to the transaction data which may be real-time and may therefore have more predictive value in terms of calculating the credit risk score for the merchant. The contribution of the financial data and the transactional data in calculating the credit risk score may therefore be weighted to counter-act the above effect.

The system may be configured to predict the interplay between the transaction data and the financial data by a machine learning algorithm in order to devise the statistical model. The machine learning algorithm may include one or more of a support vector machine, neural network, or random forest.

The statistical model may be validated and acceptance criteria established in a decision making scenario. Relative weights may then be assigned to the transaction data and the financial data.

The system may be configured to use the same statistical model for all merchants in a common category so that comparisons can be made across the category. The system may be configured to assign categories, for example, by industry, geography, and calculated risk.

A second aspect of the present disclosure provides a computer-implemented method for determining a credit risk score for an online merchant including:
a) obtaining transaction data relating to payment card transactions performed by customers at multiple merchants from a transaction database;
b) obtaining financial data relating to multiple merchants selling merchandise through an e-commerce marketplace from a financial performance database; and
c) performing, by a risk assessment component, the steps of:
   i. receiving, from a requester, an electronic request for a credit risk score for an online merchant;
   ii. extracting transaction data for the merchant and/or for similar merchants from the transaction database;
   iii. extracting financial data for the merchant and/or for similar merchants from the financial performance database;
   iv. combining the extracted transaction data and financial data in a statistical model to determine the credit risk score for the merchant; and
   v. transmitting the credit risk score to the requester.

As used throughout this specification, the term payment card may include any suitable cashless payment mechanism, such as a credit card, a debit card, a prepaid card, a charge card, a membership card, a promotional card, a frequent flyer card, an identification card, a gift card, and/or any other physical or electronic device that may hold payment account information, such as digital wallets.

Embodiments of the disclosure may be expressed as a network of communicating devices (i.e. a “computerized network”). It may further be expressed in terms of a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

Embodiments of the disclosure will now be described by way of example only with reference to the following drawings, in which:

FIG. 1 illustrates a computer-implemented method for determining a credit risk score for an online merchant in accordance with a first embodiment of the disclosure;

FIG. 2 illustrates an electronic system (i.e. computerized network of electronic devices) for performing the method of FIG. 1; and

FIG. 3 shows a block diagram of the technical architecture of a server of FIG. 2.

### DETAILED DESCRIPTION

FIG. 1 shows a computer-implemented method 10 for determining a credit risk score for an online merchant in accordance with a first embodiment of the disclosure. The method 10 includes the following steps:
a. obtaining transaction data relating to payment card transactions performed by customers at multiple merchants from a transaction database;
b. obtaining financial data relating to multiple merchants selling merchandise through an e-commerce marketplace from a financial performance database; and
c. performing, by a risk assessment component, the steps of:
   i. receiving, from a requester, an electronic request for a credit risk score for an online merchant;
   ii. extracting transaction data for the merchant and/or for similar merchants from the transaction database;
   iii. extracting financial data for the merchant and/or for similar merchants from the financial performance database;
   iv. combining the extracted transaction data and financial data in a statistical model to determine the credit risk score for the merchant; and
   v. transmitting the credit risk score to the requester.

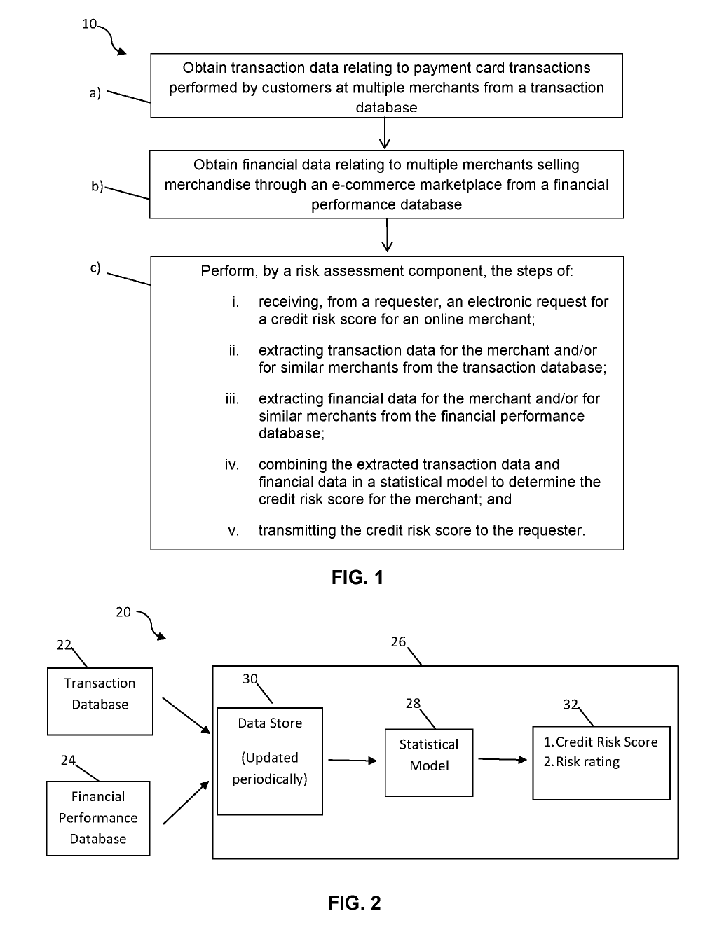

FIG. 2 illustrates a computerized network or electronic system 20 of devices for performing the method of FIG. 1. Thus, the system 20 includes a transaction database 22 including transaction data relating to payment card transactions performed by customers at multiple merchants, a financial performance database 24 including financial data relating to multiple merchants selling merchandise through an e-commerce marketplace, and a risk assessment component 26 configured for:
i. receiving, from a requester, an electronic request for a credit risk score for an online merchant;
ii. extracting transaction data for the merchant and/or for similar merchants from the transaction database 22;
iii. extracting financial data for the merchant and/or for similar merchants from the financial performance database 24;
iv. combining the extracted transaction data and financial data in a statistical model 28 to determine the credit risk score for the merchant; and
v. transmitting the credit risk score to the requester.

It should be noted that the request may be initiated by a bank, a loan provider, a potential investor, or an e-commerce marketplace provider. Furthermore, the system may be configured for individual enquiries for credit risk scores or it may be configured on a subscription-basis to provide, for example, monthly data for all or a selected group of merchants using an ecommerce marketplace.

The system may include a user interface through which a requester may submit the electronic request for a credit risk score. The user interface may be accessible via an internet-enabled device, for example via a website or user application.

The transaction data stored on the transaction database 22 may include competitor spend data, industry spend data, and geography spend data. The transaction data may be obtained from a payment card operator or bank. The transaction data may include data on individual transactions with the merchant and/or similar merchants or it may include statistical data taken from across a group of merchants in the same category, for example, industry or geography.

The financial data stored on the financial performance database 24 may include stock keeping unit (SKU) data, income statements, balance sheets, cash flow, liquidity information, frequency of use, number of transactions per period, ticket size, daily/weekly/monthly/annual online spend, etc. The financial data may be obtained from an e-commerce marketplace provider and/or from other sources.

In the embodiment of FIG. 2, the extracted financial data along with the extracted transaction data is stored in a memory or data store 30 and is updated periodically (e.g. daily/weekly/monthly) with new data from the transaction database 22 and/or financial performance database 24. Furthermore, the risk assessment component 26 is constituted by a server which is described in more detail below.

The statistical model may determine the credit risk score for the merchant based on its relative position when compared with similar merchants. Consequently, the model may consider relative ratios of financial aspects in place of absolute numbers. The financial aspects may include a measure of financial stability, ability to meet short term and/or long term liquidity needs and/or an ability to meet other financial obligations. The following known financial ratios, amongst others, may be used by the model in calculating the credit risk score: Current ratio, Quick ratio, Debt-to-Worth, Gross Margin Ratio, Net margin ratio, Sales to Assets, Return of Investment, Return on Assets, Inventory turnover, Inventory turnover days, Accounts receivable turnover, Average collection period, Accounts payable turnover, and Accounts payment period.

As the financial data is generally historical it may contribute a lagging effect to the credit risk score of a merchant and hence it may have less predictive value compared to the transaction data which may be more current and may therefore have more predictive value in terms of calculating the credit risk score for the merchant. The contribution of the financial data and the transactional data in calculating the credit risk score may therefore be weighted in step iv) to counter-act this effect.

A machine learning algorithm may be employed to predict the interplay between the transaction data and the financial data in order to devise the statistical model. The machine learning algorithm may include one or more of a support vector machine, neural network, or random forest.

The statistical model may be validated and acceptance criteria established in a decision making scenario. Relative weights may then be assigned to the transaction data and the financial data.

The same statistical model may be used for all merchants in a common category so that comparisons can be made across the category. Categories may be assigned, for example, by industry, geography, and calculated risk.

The credit risk score may be transmitted to the requester through a graphical user interface or other communication means 32. In addition, other data may be provided to the requester. For example, a risk rating or risk class may be assigned to the merchant based on a pre-determined benchmark or range of credit risk scores. Moreover, for a given category of merchant, a ranking may be provided to illustrate the risk associated with the merchant in question when compared with the risk associated with other merchants in the same category. The categories may be based, for example, on industry or geography. An example output from the graphical user interface 32 is illustrated in Table 1 below.

TABLE 1
Example output from graphical user interface

| Merchant | | | | |
|---|---|---|---|---|
| Name | Risk Score | Risk Class | Industry Rank | Geography Rank |
| Merchant 1 | 12.43 | A | 4 | 36 |
| Merchant 2 | 23.76 | B | 14 | 123 |

It will therefore be apparent that embodiments of the disclosure provide a method and system that can estimate the credit risk of an online merchant using transaction data in combination with financial data from an ecommerce marketplace. Such credit risk scores can be used by banks and/or e-commerce marketplace providers (e.g., Amazon, ebay, or AliExpress) to better assess the risk of failure of the merchant and provide a clear quantitative basis for the issuance or refusal of a loan.

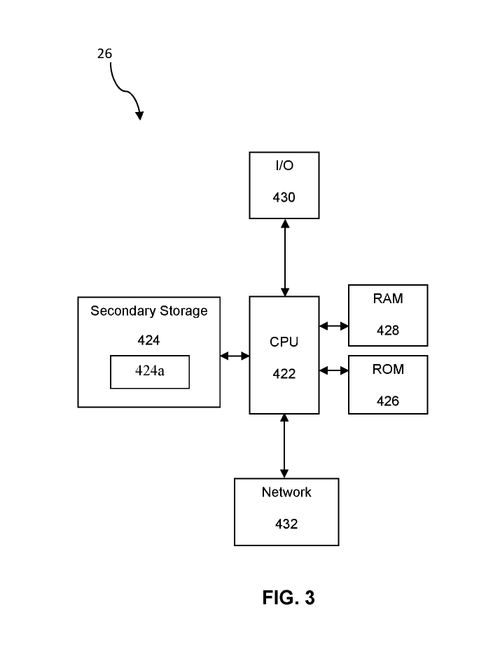

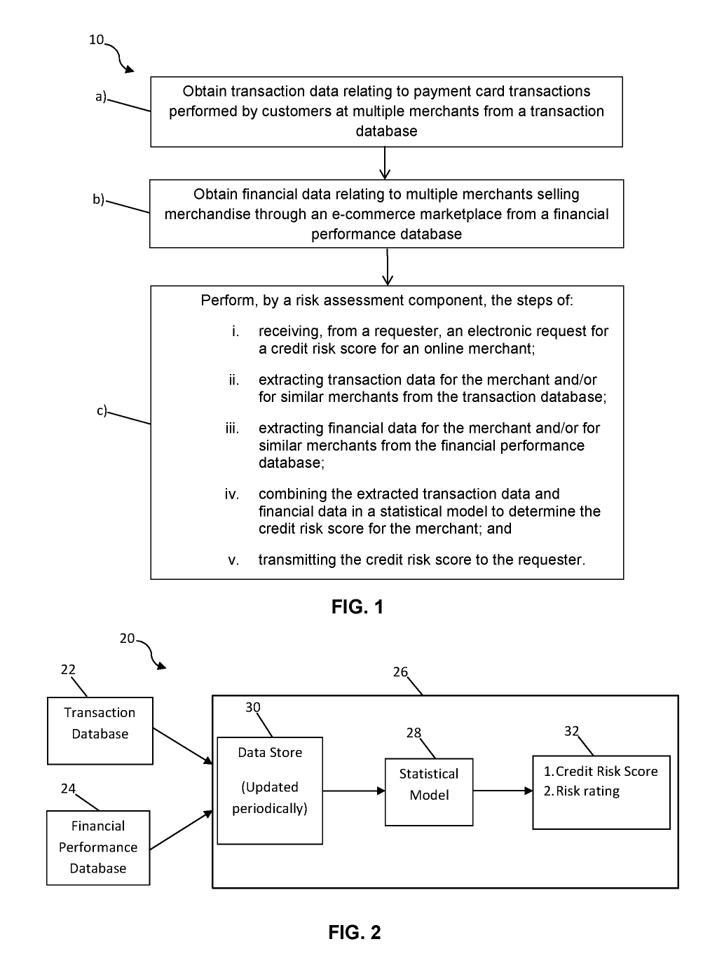

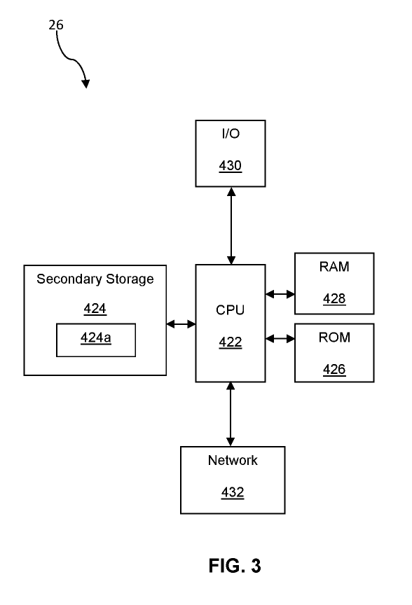

FIG. 3 is a block diagram showing a technical architecture of the server or risk assessment component 26.

The technical architecture includes a processor 422 (which may be referred to as a central processor unit or CPU) that is in communication with memory devices including secondary storage 424 (such as disk drives), read only memory (ROM) 426, and random access memory (RAM) 428. The processor 422 may be implemented as one or more CPU chips. The technical architecture may further include input/output (I/O) devices 430, and network connectivity devices 432.

The secondary storage 424 is typically includes one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a including non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 420 to provide the functionality of a number of servers that is not directly bound to the number of computers in the technical architecture 420. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made in accordance with the appended claims.

1. An electronic system for determining a credit risk score for an online merchant comprising:
a) a transaction database comprising transaction data relating to payment card transactions performed by customers at multiple merchants;
b) a financial performance database comprising financial data relating to multiple merchants selling merchandise through an e-commerce marketplace; and
c) a risk assessment component configured for:
i) receiving, from a requester, an electronic request for a credit risk score for an online merchant;
ii) extracting transaction data for at least one of the online merchant and for similar merchants from the transaction database;
iii) extracting financial data for at least one of the online merchant and for similar merchants from the financial performance database;
iv) combining the extracted transaction data and financial data in a statistical model to determine the credit risk score for the online merchant; and
v) transmitting the credit risk score to the requester.

2. The system according to claim 1 wherein the requester is at least one of a bank, a loan provider, a potential investor, and an e-commerce marketplace provider.

3. The system according to claim 1, configured for submission of an individual enquiry for a credit risk score for a specified merchant.

4. The system according to claim 1, configured on a subscription-basis to provide credit risk scores for all or a selected group of merchants using an ecommerce marketplace.

5. The system according to claim 1, wherein the transaction data comprises at least one of competitor spend data, industry spend data, and geography spend data.

6. The system according to claim 1, wherein the financial data comprises at least one of stock keeping unit (SKU) data, income statements, balance sheets, cash flow, liquidity information, frequency of use, number of transactions per period, ticket size, and daily/weekly/monthly/annual spend.

7. The system according to claim 1, configured apply a weighting to at least one of the transaction data and the financial data when determining the credit risk score.

8. The system according to claim 1, further comprising a user interface through which the requester may submit the electronic request for a credit risk score.

9. The system according to claim 8, wherein the user interface is accessible via an internet-enabled device.

10. The system according to claim 1, wherein the statistical model determines the credit risk score for the online merchant based on a relative position of the online merchant when compared with similar merchants.

11. The system according to claim 1, wherein the statistical model considers relative ratios of financial aspects.

12. The system according to claim 11, wherein the financial aspects comprise a measure of financial stability, ability to meet at least one of short term and long term liquidity needs, and an ability to meet other financial obligations.

13. The system according to claim 11, wherein at least one of the following financial ratios are used by the statistical model in calculating the credit risk score:
a. Current ratio;
b. Quick ratio;
c. Debt-to-Worth;
d. Gross Margin Ratio;
e. Net margin ratio;
f. Sales to Assets;
g. Return of Investment;
h. Return on Assets;
i. Inventory turnover;
j. Inventory turnover days;
k. Accounts receivable turnover;
l. Average collection period;
m. Accounts payable turnover; and
n. Accounts payment period.

14. The system according to claim 1, configured to predict an interplay between the transaction data and the financial data by a machine learning algorithm in order to devise the statistical model.

15. The system according to claim 14, wherein the machine learning algorithm comprises at least one of a support vector machine, a neural network, and a random forest.

16. The system according to claim 1, wherein the statistical model is validated and acceptance criteria established in a decision making scenario.

17. The system according to claim 1, configured to use the same statistical model for all merchants in a common category so that comparisons can be made across the common category.

18. The system according to claim 17, configured to assign categories by at least one of industry, geography, and calculated risk.

19. A computer-implemented method for determining a credit risk score for an online merchant comprising:
a. obtaining transaction data relating to payment card transactions performed by customers at multiple merchants from a transaction database;
b. obtaining financial data relating to multiple merchants selling merchandise through an e-commerce marketplace from a financial performance database; and
c. performing, by a risk assessment component, the steps of:
i. receiving, from a requester, an electronic request for a credit risk score for an online merchant;
ii. extracting transaction data for at least one of the online merchant and for similar merchants from the transaction database;
iii. extracting financial data for at least one of the online merchant and for similar merchants from the financial performance database;
iv. combining the extracted transaction data and financial data in a statistical model to determine the credit risk score for the online merchant; and
v. transmitting the credit risk score to the requester.

20. A non-transitory computer-readable medium having stored thereon program instructions for causing at least one processor to perform the method according to claim 19.
